(19) United States
(12) Patent Application Publication
(10) Pub. No.: US 2004/0055854 A1
(43) Pub. Date: Mar. 25, 2004

(54) Stand-alone console for collection of containers

(76) Inventor: Julio Beker Klein, Miami, FL (US)

Correspondence Address: Julio Beker Klein, 5524 NW, 114th Ave. #205, Miami, FL, 33178-3585, US

(21) Appl. No.: 10/251,532

(22) Filed: Sep. 23, 2002

(51) Int. Cl. G07F 7/00

(52) U.S. Cl. 194/205

(57) ABSTRACT

An unmanned, stand-alone console for collection of recyclable container is disclosed. This console includes attitude influencing graphics or a message promoting recycling, instructions for use of the console and one or more portals in the console for deposit of a recyclable container into the console. The preferred embodiments of the console of this invention includes releasable access panels to permit servicing of the console and the removal of containers that have been deposited for recycling. The releasable access panels include tamper-proof means for securing these access panels in a closed or locked position.

### BACKGROUND OF THE INVENTION

1. Field of the Invention

This invention relates to an article of manufacture. More specifically, this invention is directed to an unmanned, stand-alone structure for collection of recyclable containers, preferably beverage containers fabricated from plastic (e.g. PET), aluminum or glass. This stand-alone structure is self-contained in the sense that it need not be attended to perform its collection function.

2. Background of Invention

The task of recycling containers generally involves the sorting of such container collected incident to refuse collection, and thereafter processing such containers in a recycling plant prior to grinding/shredding.

The following patents are representative of the devices used in the recycling of beverage containers, such as plastic bottles and aluminum cans. These patents are discussed in chronological order, based upon their date of issue; and, thus, no significance is to attach to the order of their discussion.

U.S. Pat. No. 5,111,927 (to Schulze, Jr., issued May 12, 1992) discloses an automated, stand-alone, unmanned recycling and vending machine for recycling used beverage containers, typically those beverage containers which are the subject of “bottle bills” which provide for return of redemption value upon recycling of the used beverage containers. The recycling machine comprises a series of interrelated modules having means for receiving, sensing, classifying, segregating and/or rejecting various types of effectively exploited outside the school environment. Accordingly, there exists a need to provide an accessible, non-intrusive method and means for collection of recyclable products, specifically product containers. In order to enhance the success of such effort, the expedients chosen to accomplish this objective should preferably appeal to individuals, such children and parents of children, that have an acquired inclination to sort and deposit such container for recycling. Unfortunately, nothing presently exists to take advantage of such positive recycling attitudes, or to develop such attitudes in others. Accordingly, there continues to exist a need to provide a simple and effective means for cost effective, collection of recyclable containers which does not require elaborate construction, maintenance, or involve complex processing operations.

### OBJECTS OF THE INVENTION

It is the object of this invention to remedy the above as well as related deficiencies in the prior art.

More specifically, it is the principal object of this invention to provide an unmanned, stand-alone console for collection of recyclable containers.

It is another object of this invention to provide an unmanned, stand-alone console for collection of recyclable containers of simplified construction and operation.

It is still yet another object of this invention to provide an unmanned, stand-alone console for collection of recyclable containers which appeals to children and promotes recycling attitudes in others.

Additional objects of this invention include an improved method of collection of recyclable beverage containers.

### SUMMARY OF THE INVENTION

The above and related objects of this invention are achieved by providing an unmanned, stand-alone console wherein the console includes attitude influencing graphics or a message promoting recycling, instructions for use of the console and one or more portals in the console for deposit of a recyclable container into the console. The preferred embodiments of the console of this invention includes releasable access panels to permit servicing of the console and the removal of containers that have been deposited for recycling. The releasable access panels include tamper-proof means for securing these access panels in a closed or locked position.

In another of the preferred embodiments, the interior of the console is provided with means for dispensing of a deodorizing spray or mist to both retard bacterial growth and neutralize or mask odors that can evolve from the containers and their contents. This deodorizing spray is dispensed within the console onto the collected containers, either periodically, based upon a timer or clock associated with the console, or manually activated upon insertion of a container through one of the portals located in the console exterior wall.

In another of the preferred embodiments of this invention the console is provided with dynamic or changing graphics to both attract potential depositors, and to create/reinforce positive recycling consumer attitudes. These graphics can include a periodically changing poster or message; and/or a hologram; and/or some pleasant audible tone, music or voice. In one of the preferred embodiments of this invention, this consumer oriented graphic or message would be periodically changed, either from a remote location, or at the time of servicing the console. In another of the preferred embodiments of this invention, the console message could include advertising of environmentally friendly products to further enhance recycling attitudes. In another of the preferred embodiments of this invention, the console would dispense a token, coupon or the equivalent, as a “reward” for depositing a recyclable container in the console. This reward would preferable have some form of corporate sponsorship; and, such reward would be redeemable by the sponsor at its establishment for merchandise (e.g. Ronald McDonalds tokens redeemable for a complimentary drink or prize). In another of the preferred embodiments of this invention the console would a have graffiti proof surface, or alternatively, a work space for creative neighborhood children to post their pictures.

Custom consoles of this invention can include or be configured as a recognizable figure or personality to further enhance consumer awareness.

### BRIEF DESCRIPTION OF THE DRAWINGS

FIG. 1 is a perspective view of the unmanned, self-contained recycling console of this invention.

FIG. 2 is a series end-on views of the unmanned, self-contained recycling console of FIG. 1.

FIG. 3 is a perspective view of the interior of the console, when viewed through the open panel in the rear of the console.

### DETAILED DESCRIPTION OF THE INVENTION INCLUDING PREFERRED EMBODIMENTS

The Figures which accompany this application, and referenced herein, depict a representative embodiment of the portable cooling device of this invention. In the embodiments of this invention illustrated in these Figures, one or more components of the integral device may appear in more than one Figure. Accordingly, components which are common to more than one Figure are assigned a common reference numeral for continuity of description and ease of understanding.

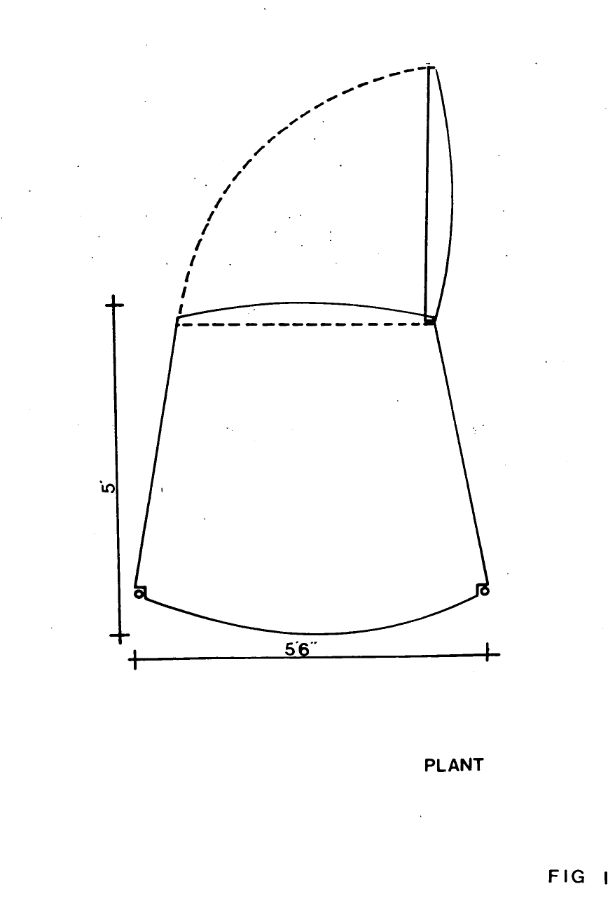

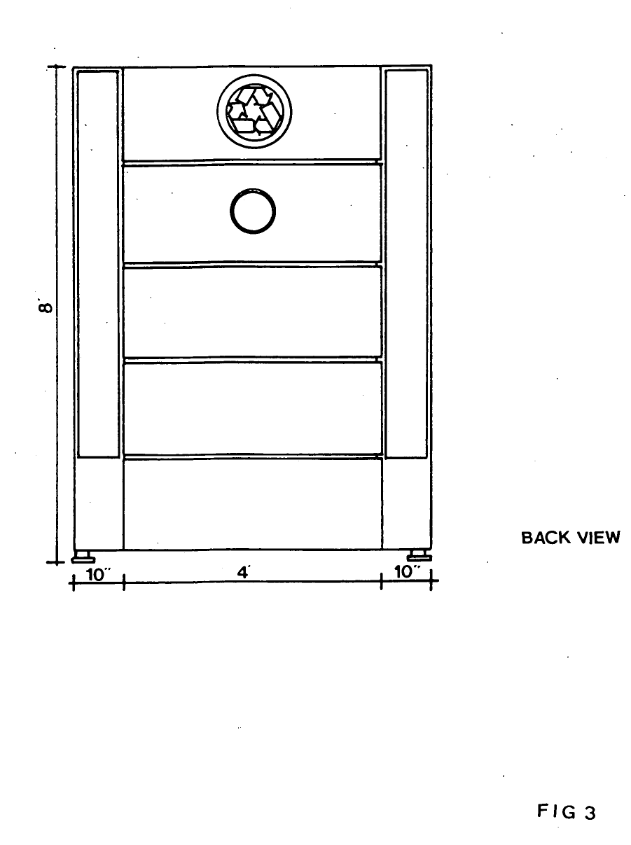

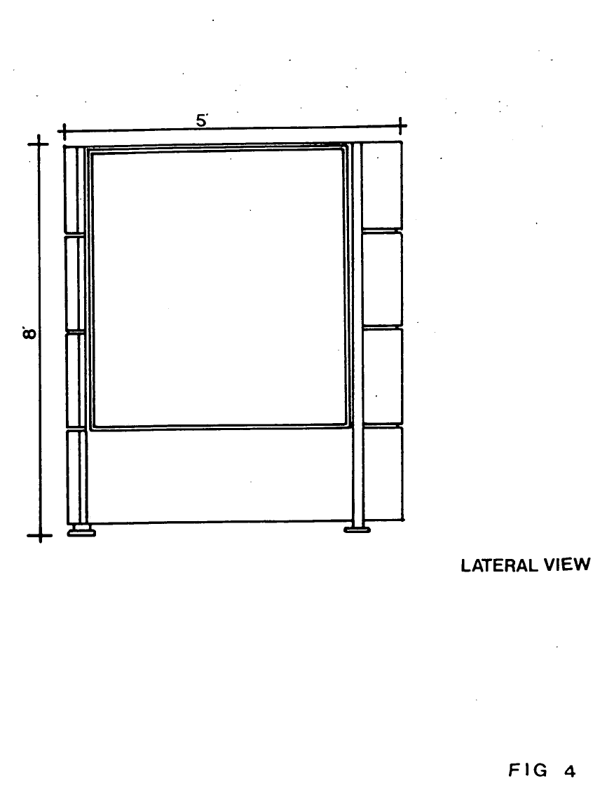

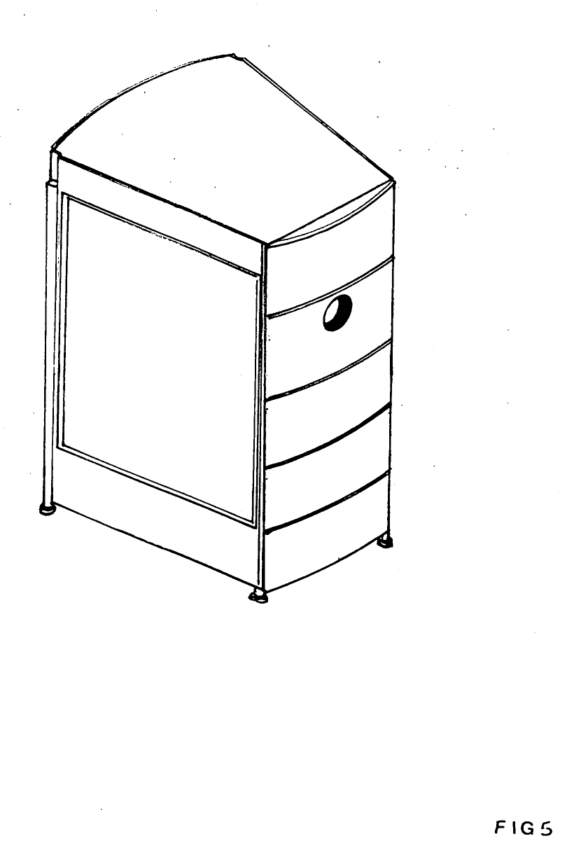

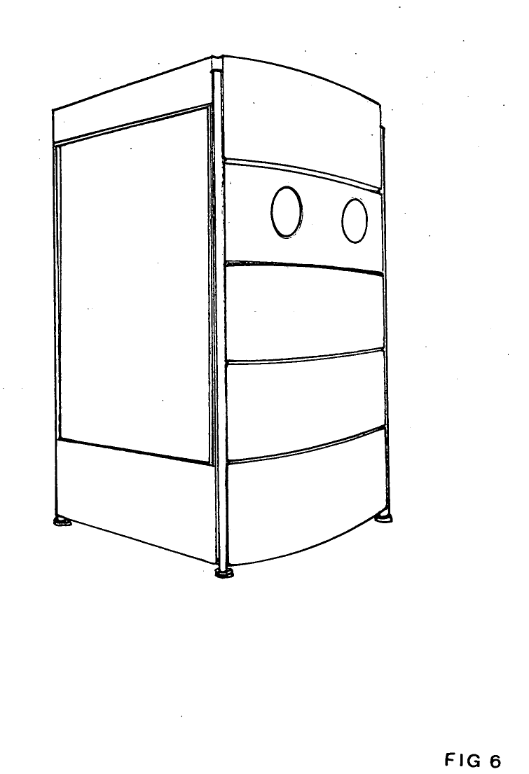

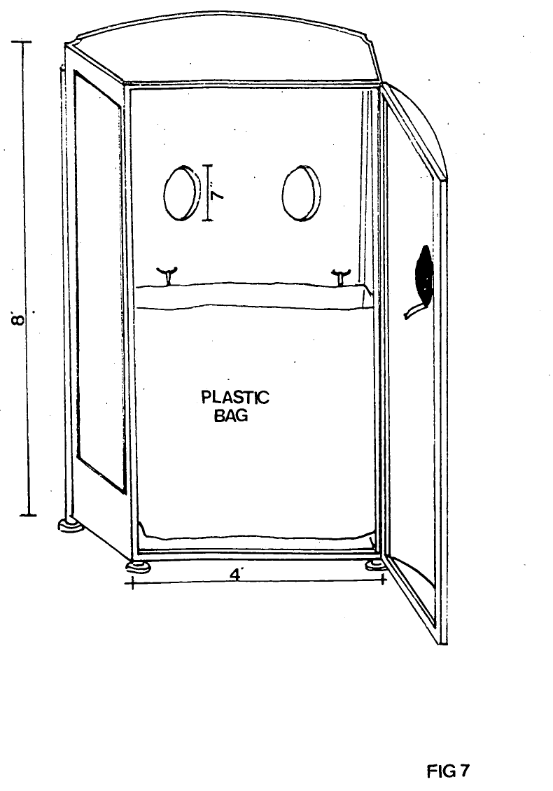

FIG. 1 illustrates a perspective view of a representative unmanned self-contained recycling console of this invention when viewed from the front. In the embodiment of this invention illustrated in FIG. 1, the recycling console (10) comprises an asymmetric structure wherein each of the front (12) and rear (14) panels of the console include one or more portals (16) for deposit of a recyclable container in the console. Each of these portals (16) are preferably positioned on the upper surface of each front (12) and rear (14) panel to insure sufficient height for clearance of the top of the collection bins (28 of FIG. 3) housed therein. These collection bins (28) can include a basket or tub having a liner. This liner is removal and is sealable, to permit transport the recyclable containers from the console to the service unit that periodically empties the console.

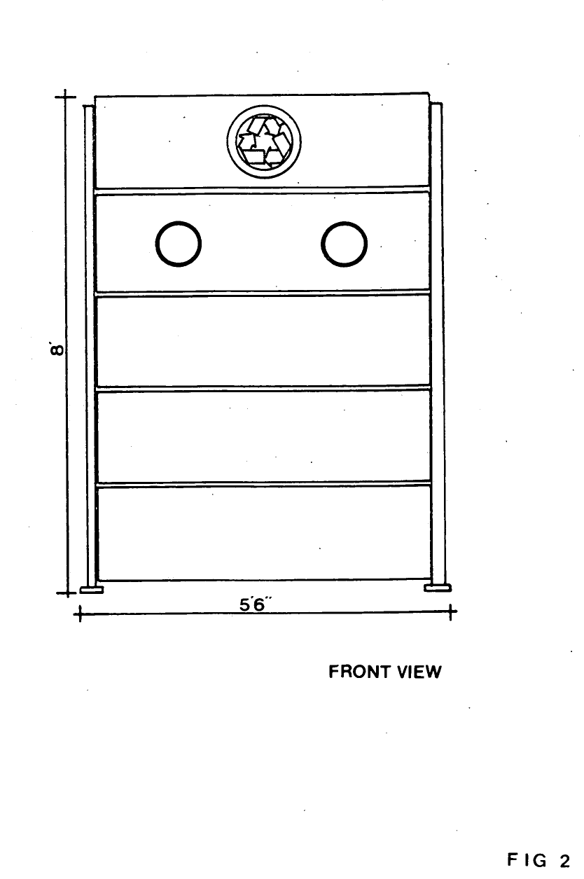

As illustrated in FIGS. 2 & 3, one of the panels of the console is pivotally or slidingly attached to the console, and, upon displacement upward, or sideways, allows access to the interior of the console and thereby servicing through removal of collected bottles and cans, and reloading of a deodorizer dispenser that may be disposed therein.

The base of the console is fixedly mounted to an immovable, stationary pad (concrete pad or suitable anchor). The base of the console is preferable formed in the shape of a bowl to both contain any fluid that may inadvertently escape from the collection bins, and to prevent seepage of liquid from outside of the module into the interior thereof. In the preferred embodiments of this invention, the base of the module includes means for attachment of the base of the console to a concrete pad or other suitable anchoring means. In one of the preferred embodiments of this invention, rails are molded into the base for slide mounting into a formed recess in a concrete pad or anchoring means. The module is thereafter simply locked in place from within the console; and, conversely, can be readily removed from the pad by simply reversing this process.

The description and examples, as above provided, is illustrative of a number of the preferred embodiments of this invention. This description and examples are neither intended, nor should they be construed to delineate the scope of this invention, which has been reserved for the claims that follow.

What is claimed is:

1. In an unmanned self-contained bin for collection of recyclable containers, including recyclable bottles and cans, the improvement comprising:
A. A console characterized as an essentially closed structure having at least one portal for inserting a recyclable container into said console,
said console being further characterized as fabricated from an assemble of interconnected parts, including a base, a plurality of side panels and a lid affixed to said side panels wherein said lid may be displaced thereby permitting access to the interior of said console,
said portal including a displaceable, self-sealing closure for access to said interior of said console from outside said console, thereby permitting deposit of a recyclable container into said console;
B. At least one collection bin positioned within said console, said bin having an open end and a closed end, and a removable liner that conforms essentially to the interior dimensions of said bin; and
C. Means for dispensing a deodorizer in response to a mechanical pulse or a timing mechanism.

2. The unmanned self-contained bin of claim 1, wherein the said console comprises four sides, at least one of which includes a portal, and at least one of which includes a graphic or a message promoting recycling.

3. The unmanned self-contained bin of claim 1, wherein said console includes at least one bin within said console, said bin having a removable liner for transfer of recyclable containers from said console to a remote site for further processing.

4. The unmanned self-contained bin of claim 1, wherein said console includes a base having means for coupling to an immovable pad or anchoring means.

5. The unmanned self-contained bin of claim 1, wherein said console includes a series of interlocking panels that can be assembled and disassembled without tools.
